(19) United States
(12) Patent Application Publication
(10) Pub. No.: US 2011/0316920 A1
(43) Pub. Date: Dec. 29, 2011

(54) EJECTION CHARACTERISTICS EVALUATION APPARATUS AND EJECTION CHARACTERISTICS EVALUATION METHOD FOR INKJET PRINTING APPARATUS, AND INKJET PRINTING APPARATUS

(75) Inventors: Makoto Torigoe, Tokyo (JP); Fumitaka Goto, Tokyo (JP); Nobutaka Miyake, Yokohama-shi (JP); Tohru Ikeda, Yokohama-shi (JP); Akitoshi Yamada, Yokohama-shi (JP); Tomokazu Ishikawa, Kawasaki-shi (JP)

(73) Assignee: CANON KABUSHIKI KAISHA, Tokyo (JP)

(21) Appl. No.: 12/966,757

(22) Filed: Dec. 13, 2010

(30) Foreign Application Priority Data
Jun. 23, 2010 (JP) 2010-143095

(51) Int. Cl. B41J 29/38

(52) U.S. Cl. 347/14

(57) ABSTRACT

The present invention prints a plurality of ejection characteristics detection patterns with different print duties. Each of the patterns is divided into areas with a certain number of pixels, and each area is read with a plurality of different read colors. Based on the read values by the read color for each area, evaluation values by the read color that indicates ejection variation volume that is the difference between ink ejection volume to each area and standard ink ejection volume are set. A weighted average is obtained by applying the weight determined by reading accuracy of a reading unit to evaluation values by color for each area with different print duties formed by the same nozzle. The ejection characteristics of a nozzle that prints each of the areas are evaluated using the weighted average value.

### BACKGROUND OF THE INVENTION

1. Field of the Invention

The present invention relates to an ejection characteristics measurement apparatus and ejection characteristics measurement method for inkjet printing apparatus and inkjet printing apparatus, in particular to evaluation of ejection characteristics of print heads required to prepare correction data used for head shading of print heads.

2. Description of the Related Art

Inkjet printing apparatuses to print color images using a plurality of ink colors are equipped with a plurality of print heads corresponding to each of the ink colors. Due to causes such as a manufacturing error, ejection characteristics are varied for each nozzle of the plurality of print heads. The variation of ejection characteristics causes color variations and density unevenness in images. Particularly in a printing apparatus with premises of 1-pass printing that completes an image by causing a line head longer than the width of the print medium to scan only once over the print medium, although the image can be printed at high-speed, density unevenness is more likely to occur compared to multi-pass printing. That is, in multi-pass printing, each raster can be printed using different nozzles so that density unevenness caused by the variation of ejection characteristics of nozzles can be reduced. However, in 1-pass printing in which each raster is printed by a single nozzle, ejection characteristics of the nozzle significantly affect the density of the image. Therefore in a printing apparatus of 1-pass printing, in accordance with ejection characteristics of a nozzle comprising a head, operation control of the nozzle to reduce density unevenness in an image, that is, head shading (HS) is required. In order to accurately perform such head shading, it is necessary to determine the aforementioned ejection characteristics of the nozzle as precisely as possible.

Japanese Patent Laid-Open No. H04-018364 (1992) of this applicant discloses the technology to perform such head shading. In the technology, density unevenness of patterns in a single color printed with a plurality of different ink ejection volumes (duties) are read by an optical reader using a complementary color of each of the single color. Subsequently, for a read value of a pattern printed with a duty with which density change appears sensitively, a weighted average is obtained by applying a large weight. Based on the weighted average value, the amount of signal compensation for each of the print heads is determined. According to the technology, head shading can be performed more precisely compared to a case in which the ejection feature of the nozzle are determined based on the read value of a pattern printed with a certain duty.

However, since the technology disclosed in said Japanese Patent Laid-Open No. H04-018364 (1992) determines the compensation value for head shading according to a read value obtained by reading the density unevenness in a single color pattern with a single complementary color, there exists the problem where adequate accuracy cannot be provided. On the other hand, enhancement of accuracy by increasing the pattern area of each duty and reading various positions in each pattern printed with the same duty has been proposed and implemented. In such a case, however, along with the increase of pattern areas formed for each duty, the problem of quality decline in total throughput of the printing operation occurs as the time to print patterns is increased, and at the same time, the problem of cost escalation occurs as ink consumption is increased.

### SUMMARY OF THE INVENTION

It is an object of the present invention to provide an ejection characteristics evaluation apparatus for print heads that is capable of evaluating ejection characteristics of print heads precisely without increasing areas of detection patterns.

In order to achieve the above objective, the present invention has the following configuration.

The first aspect of the present invention is an ejection characteristics evaluation apparatus to evaluate ink ejection characteristics of a plurality of nozzles provided in print heads used for inkjet printers comprising: a print control unit configured to print a plurality of ejection characteristics detection patterns with different print duties, that are ratios between the number of all pixels within a unit area and the number of pixels in which a dot is formed on a print medium, by the print heads; a reading unit configured to divide each of the plurality of ejection characteristics detection patterns into areas having a predetermined number of pixels and to read each of the areas with a plurality of read colors; an evaluation value setting unit configured to specify, based on the read values by the read color obtained by the reading unit for each area, an evaluation value for each of the read colors that indicates an ejection variation volume that is the difference, in each area, between ink ejection volume in each area and standard ink ejection volume; and a comprehensive evaluation unit configured to obtain a weighted average value by applying weights determined based on reading accuracy of the reading unit to the evaluation value for each of the read colors of each area with different duties formed by the same nozzle and evaluate ejection characteristics of a nozzle that prints each of the areas using the weighted average.

The second aspect of the present invention is an inkjet printing apparatus an inkjet printing apparatus to print an image on a print medium by using a plurality of print heads with a plurality of nozzles to eject ink and ejecting different ink colors from the plurality of print heads, the inkjet printing apparatus comprising: a print control unit configured to print a plurality of ejection characteristics detection patterns with different print duties, that are the ratios between the number of all pixels within a unit area and the number of pixels in which dots are formed on a print medium, by the print head; a reading unit configured to divide each of the plurality of ejection characteristics detection patterns into areas with a certain number of pixels and read each of the areas with a plurality of read colors; an evaluation value setting unit configured to specify, based on the read values by the read colors obtained by the read method for each area, an evaluation value for each of the read colors that indicates an ejection variation volume which are the difference, in each area, between ink ejection volume in each area and standard ink ejection volume; a comprehensive evaluation unit configured to obtain a weighted average value by applying weights determined based on reading accuracy of the reading unit to the evaluation value for each of the read colors of each area with different duties formed by the same nozzle and evaluate ejection characteristics of a nozzle that prints each of the areas using the weighted average; and a correction unit configured to correct ink ejection volumes from the print heads to the print medium so that the weighted average value is decreased.

According to the present invention having the configuration described above, highly-accurate evaluation of ejection characteristics of print heads is enabled without increasing areas of detection patterns and the total printing operation throughput can be improved and ink consumption can be reduced compared to before.

Further characteristics of the present invention will become apparent from the following description of exemplary embodiments (with reference to the attached drawings).

### BRIEF DESCRIPTION OF THE DRAWINGS

FIG. 1 is a plan view schematically illustrating the construction of a color inkjet printing apparatus to which the ejection characteristics measuring method of the embodiment of the present invention is applied;

FIG. 2 is a schematic diagram illustrating the internal and peripheral constructions of the scanner in FIG. 1;

FIG. 3 is a block diagram illustrating the basic construction of the control system for the inkjet printing apparatus in FIG. 1;

FIG. 4 is a flowchart illustrating a series of operations in the ejection characteristics measuring method of the embodiment;

FIG. 5 is a diagram illustrating an example of ejection characteristics detection pattern formed in the embodiment;

FIG. 6 is a diagram illustrating, by R, G, and B and by printing duty, the variations of the read values obtained by the scanner in relation to the ejection volume variations of print heads when the cyan pattern shown in FIG. 5 is printed;

FIG. 7 is a graph illustrating the variations of the read values in relation to ΔL;

FIG. 8 is a diagram illustrating the characteristics obtained by deducting errors (σ) from ΔRGB/ΔL of each of the RGB colors in FIG. 7; and

FIG. 9 is a diagram illustrating the coefficient table stored in ROM of the embodiment.

### DESCRIPTION OF THE EMBODIMENTS

In reference to the attached diagrams, embodiments of the present invention will be explained.

Embodiments of inkjet printing apparatus, ejection characteristics evaluation measurement apparatus and ejection characteristics evaluation method according to the present invention will be explained based on diagrams.

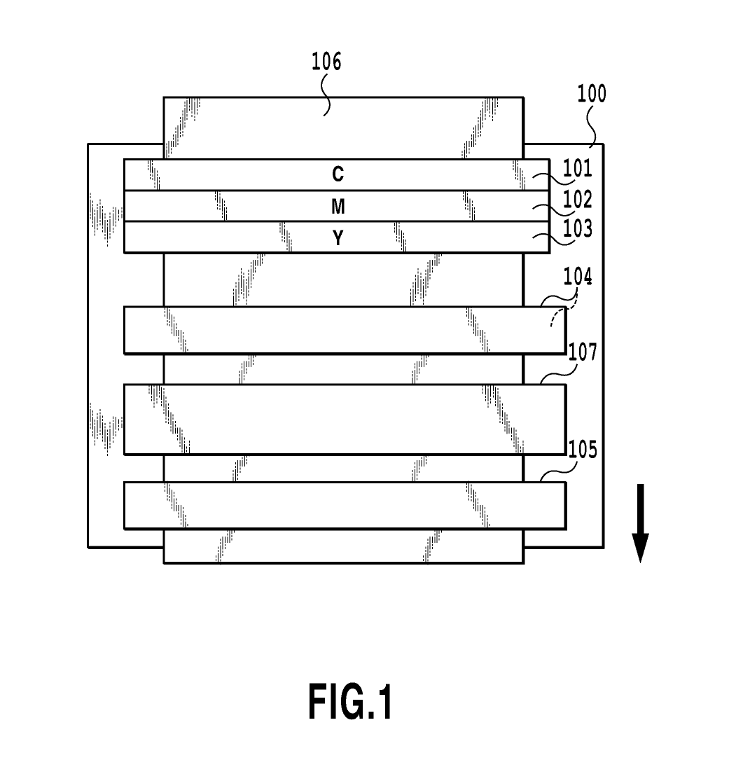

FIG. 1 is a plan view schematically illustrating the construction of a color inkjet printing apparatus according to the embodiment of the present invention. A printing apparatus body 100 in FIG. 1 has print heads 101 to 103 that are able to eject ink. The print heads 101, 102, and 103 illustrate a print head to eject cyan (C), magenta (M), and yellow (Y) ink respectively. For each of the print heads 101 to 103, a plurality of nozzles is arranged along the direction perpendicular to the conveying direction of the print medium (direction shown by the arrow in the diagram), and the range of nozzle arrangement is wider than the width of the print medium 106 (length in a direction perpendicular to the conveying direction). A print head having such construction may be called a “long head” below. Most inkjet printing apparatuses have a head to eject black ink in addition to C, M, and Y. However, for the purposes of simplicity, a print apparatus with only C, M, and Y print heads will be described.

The inkjet printing apparatus also includes a pair of conveying rollers 104 that are rotated by the motion of a line feed motor 105 and conveys the print medium 106 in the direction of the arrow in the diagram. Further, the inkjet printing apparatus has an image scanner 107 (hereinafter referred to as a “scanner”) on the downstream side of the conveying direction of the print medium in relation to the print heads 101 to 103 and the conveying rollers 104. The scanner 107 is capable of reading an image printed on the print medium 106 by the print heads 101 to 103 as three-color outputs of R (red), G (green), and B (blue).

In such a printer, 1 raster of an output image is formed as ink is ejected from each head of C, M, and Y once respectively. Synchronizing with the line feed motor conveying the print medium, an image for one page is formed by repeating the ink ejection operation. As described above, the inkjet print apparatus using a long head according to the present embodiment is a full-line type printing apparatus that consecutively conveys the print medium 106 in the direction of the arrow in the diagram and ejects ink from the nozzles of each print head to print, that is, performs 1-pass printing. In other words, each nozzle of every print head prints each raster (line) consisting an image by scanning once.

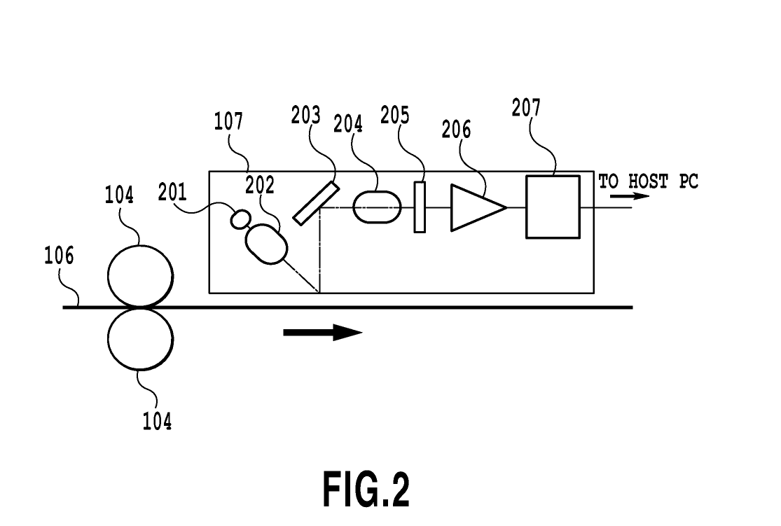

FIG. 2 is a lateral view of the peripheral area of the scanner 107 in the inkjet printing apparatus in FIG. 1. In FIG. 2, the print medium 106 is conveyed by the operation of the conveying roller 104 in the direction perpendicular to the scanner 107, while keeping a constant distance from the scanner 107. In the scanner 107, a white LED 201 capable of emitting visible light (wave length of approximately 400 to 700 nm) having a continuous spectrum is provided as a reading light source. The light generated from the white LED 201 is irradiated to the face of the print medium 106 linearly by the operation of a light guide body 202. The part of the light irregularly reflected by the print medium 106 is reflected by a reflection mirror 203, and the reflected light enters into one-dimensional CCD 205 via a reduction/image formation lens 209. In the CCD 205, the reduced image of the image printed on the print medium 106 is formed by the operation of the reduction lens 204.

The CCD 205 has a certain number of pixels (for instance, 600 dpi on a print medium) within the length obtained by reducing the reading width of the scanner corresponding to the width of the print medium 106 by the reduction ratio β of the image formation lens 204 and consists of three sensor arrays covered by R, G, and B color filter respectively. Therefore, a signal obtained by reading each color component of R, G, and B is outputted for each pixel. The output signals are amplified by an amplifier 206 first and then outputted as digital signals through the A/D converter 207. As described above, the scanner 107 outputs, as R, G, and B data of each pixel, one-dimensional digital signals obtained by reading the one-dimensional image on the print medium 106 that matches the longitudinal direction (direction perpendicular to the conveying direction of the print medium) of the print heads 101 to 103. Further, the print medium 106 is conveyed in the direction of the arrow in the diagram (sub-scan direction), and by repeating the one-dimensional reading described above at a certain timing (for instance, timing corresponds to 600 dpi on a print medium), two-dimensional digital scan signals of the print medium 106 can be obtained.

The two-dimensional digital signals obtained by the scanner 107 as described above are eventually sent to a host PC 300 described below.

The scanner 107 is configured to disperse the obtained scan light into RGB on the sensor side; however, a configuration in which LED to generate R, G, and B lights is provided as an optical source to read light by switching the optical source as the print medium 106 is conveyed by one pixel may be used. Also, the reduction/image formation lens 204 is used as the imaging optics of the present embodiment; however, Selfoc lens array that is an imaging optics of one-to-one magnification may be used.

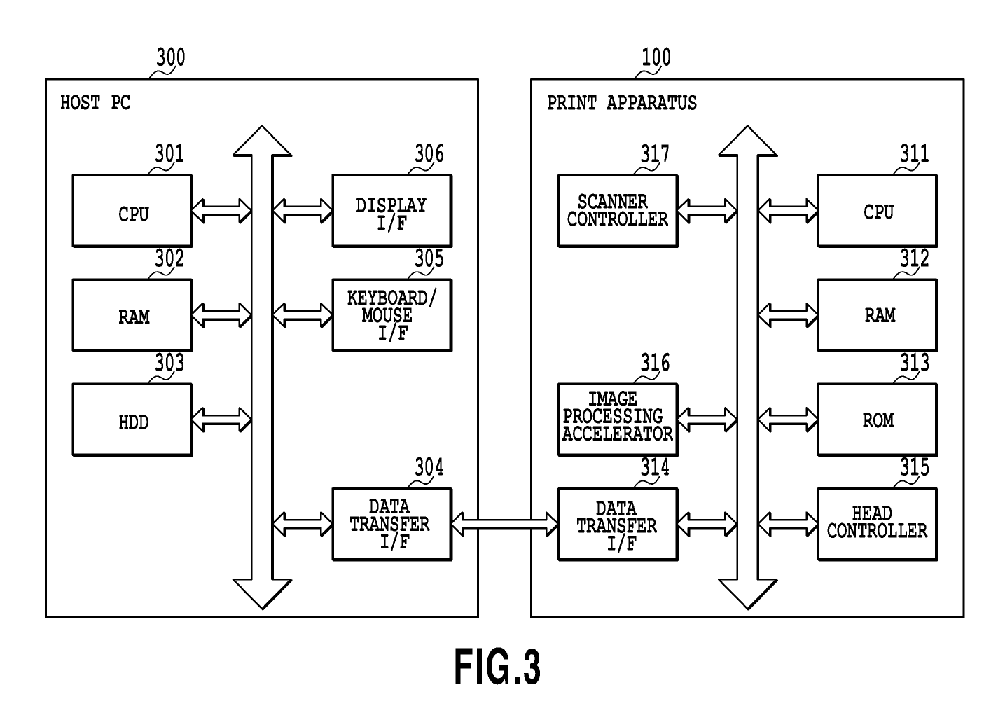

FIG. 3 is a diagram showing an example of a configuration of the control system of the present embodiment.

In FIG. 1, 100 indicates the inkjet printing apparatus body, and 300 is a host PC (personal computer) that sends print data to the inkjet printing apparatus body 100. The host PC 300 mainly comprising CPU 301, RAM 302, a hard disk 303, a display interface (I/F) 306, a keyboard mouse I/F 305, and a data transfer I/F 304. The CPU 301 performs various processing such as computing, detection, and control based on programs stored in the HDD 303 and RAM 302. Further, the CPU 301 functions as a print control unit to control the printing operation of print heads and plays roles of evaluation value setting unit and comprehensive evaluation unit to determine the evaluation value and comprehensive evaluation value described below. In addition, the RAM 302 is a volatile storage which is a block to temporarily store programs and data. The HDD 303 is a non-volatile storage which is a block to store programs and data. The data transfer I/F 304 is I/F to send/receive data between the printing apparatus body 100 and the host PC. Physical methods to connect the host PC and the printing apparatus body include, for instance, USB, IEEE1394, and LAN. The keyboard mouse I/F 305 is I/F to control HID (Human Interface Device) such as a keyboard or mouse and receives inputs from a user. The display I/F 306 is I/F to connect the display and the host PC.

In addition, the printing apparatus body 100 has the following configuration.

CPU 311 functions as a control unit, computing unit, and setting unit that perform various processing such as computing, detection, and control based on the program stored in ROM 313 and RAM 312. The RAM 312 is a volatile storage that temporarily stores programs and data. The ROM 313 is a non-volatile storage that stores programs and data. Data transfer I/F 314 is I/F to send/receive data to/from the PC 300.

A head controller 315 supplies print data to the print head that actually performs printing and controls printing. In particular, the head controller 315 is designed to read necessary parameters and data from a predetermined address on the RAM 312. The CPU 311 writes necessary parameters and data to the predetermined address on the RAM 312, activates the head controller 315, and starts actual printing operation.

An image processing accelerator 316 performs image processing at a higher speed than the CPU 311. In particular, the image processing accelerator 316 reads necessary parameters and data from a predetermined address on the RAM 312. When the CPU 311 writes necessary parameters and data in the predetermined address on the RAM 312, the image processing accelerator 316 is activated, and actual printing operation is performed. Note that this image processing accelerator 316 is not necessarily required, and image processing may be done by the CPU 311 only.

Next, an ejection characteristics measurement method of long print heads used for the inkjet printing apparatus in FIG. 1 will be explained.

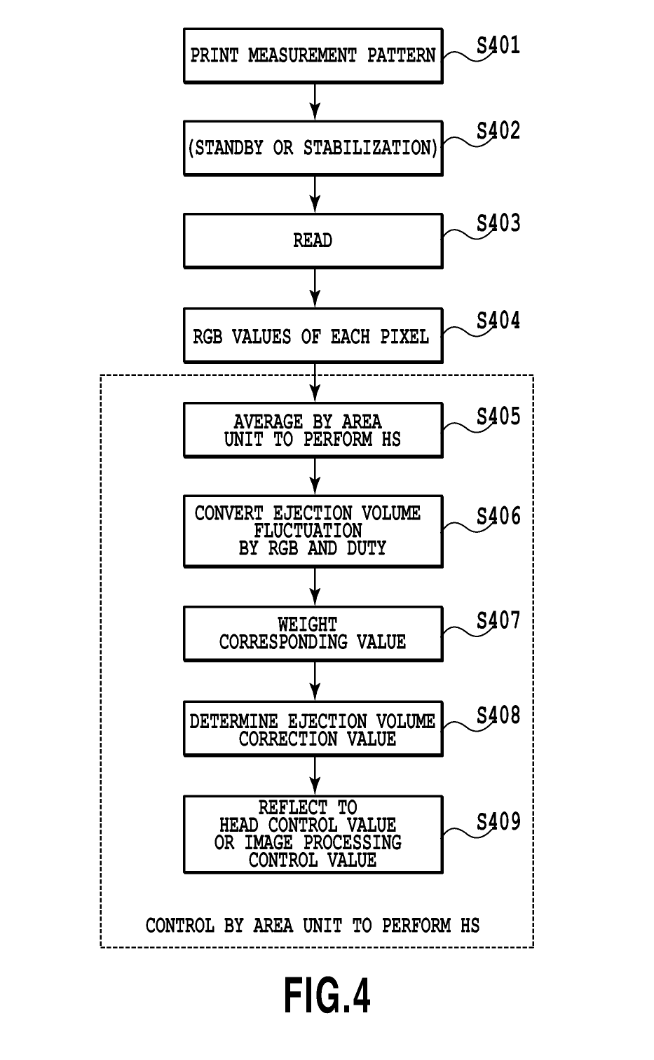

FIG. 4 is a flowchart illustrating a series of operations for the ejection characteristics evaluation method of the present embodiment. The operations will be explained with reference to this flowchart.

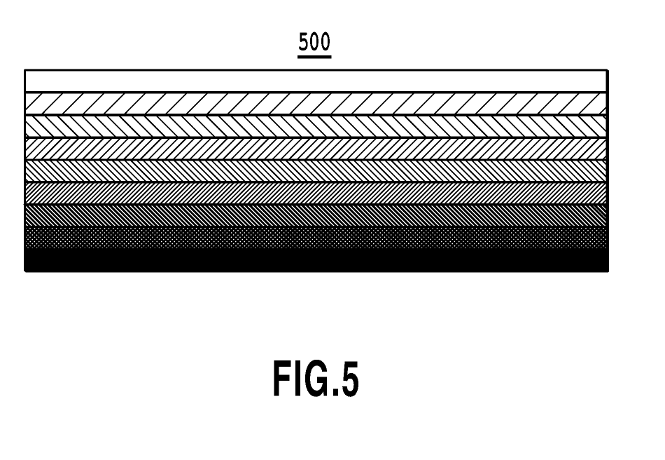

First of all, as described above, an ejection characteristics detection pattern is printed on the print medium 106 by the conveying operation of the print medium 106 in the direction of the arrow and ejection operation from each head 101 to 103 (S401). FIG. 5 illustrates an example of ejection characteristics detection pattern. FIG. 5 shows an ejection characteristics detection pattern printed with only C (cyan) color; however in practice the same pattern is formed for every ink color to be used. That is, patterns in M (magenta) and Y (yellow) colors are also printed. The ejection characteristics detection pattern 500 in FIG. 5 illustrates a pattern in a single color of C with various print duties. Here, the print duty is the ratio between the number of all pixels within a unit area and the number of pixels in which a dot is formed on the print medium. Therefore, for example, when a dot is formed in all pixels within the unit area set on the print medium 106, the print duty is 100%. Also, when a dot is formed in 10% of pixels among all the pixels within the unit area, the print duty is 10%. In the present embodiment, nine levels of print duty patterns for every 10% between 20% and 100%, that is, 9 patterns are provided.

Next, the printed pattern 500 is read by the scanner 107 by each read color of R, G, and B (S403). As a result, R, G, and B values of each pixel are obtained for each print duty (S404). However, in the case of using dye ink, colors may be unstable after ejection characteristics detection patterns are printed. For this reason, as shown in S402, a certain amount of standby time may be inserted between the printing operation and reading operation, or time to promote stabilization of the ink using fixing means such as a dryer may be added.

Incidentally, in head shading, image data may be corrected for each pixel to be printed corresponding to each nozzle of the heads 101 to 103. However, since a large number of nozzles are used in a long head as in the present embodiment, in the case of correcting image data for each pixel, the load of performing data processing becomes larger. Therefore, by dividing printed patterns with each print duty into areas with a certain number of (plural in this case) pixels and reading patterns of each area unit, head shading may be performed for each nozzle group unit that printed each area. Based on the space frequency that is visible as density unevenness on the image, the size of each area is determined so that it becomes smaller than the space frequency. Here, an example of performing such head shading by area unit will be described. Thus the following sequence is controlled by the area unit.

The R, G, and B values of each pixel obtained in S404 are averaged for each area unit (S405). The respective average values of R, G, and B are converted into ejection volume variation values using the coefficient Knm obtained with reference to the coefficient table preliminarily stored in the ROM 313 by color (by RGB) and by print duty of the pattern (S406). The method of converting into ejection volume variation values will be described below.

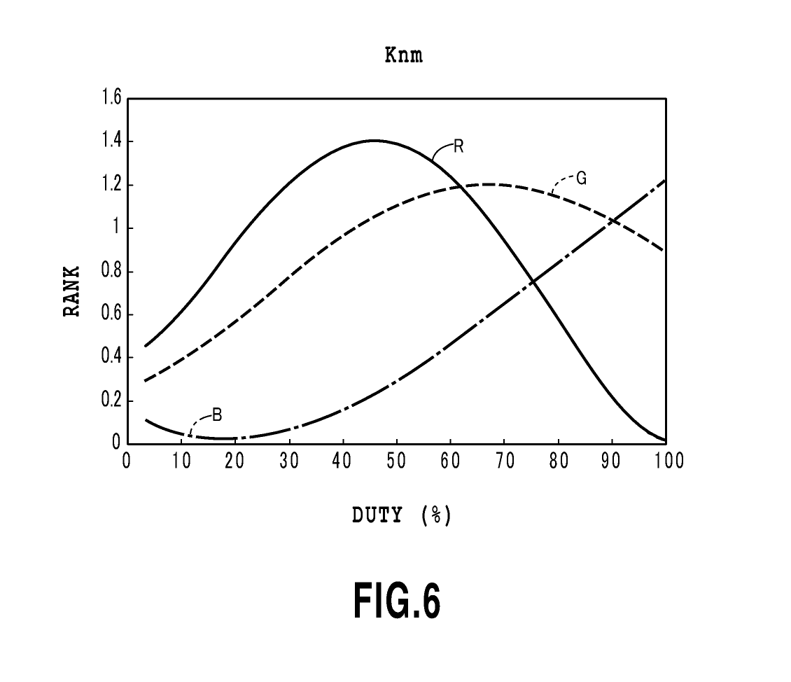

FIG. 6 is a diagram illustrating the change in variation volume ΔR, ΔG, ΔB (hereinafter referred to as “ΔR, G, B”) of read values obtained by the scanner 107 in relation to the ejection volume variation of the print head by R, G, B and by print duty of the pattern when the cyan pattern 500 shown in FIG. 5 is printed. Here, the horizontal axis of FIG. 6 shows the print duty, and the vertical axis shows the variation volume (ΔR, G, B) of read values obtained by the scanner 107 in relation to one unit of ejection variation volume of print head called “rank”. That is, this variation volume corresponds to the degree of efficiency (coefficient Knm) that indicates the variation of read value obtained by the scanner 107 in relation to the ejection variation volume of the print head. The values shown in this graph are same as that stored in the ROM 313 as the coefficient table.

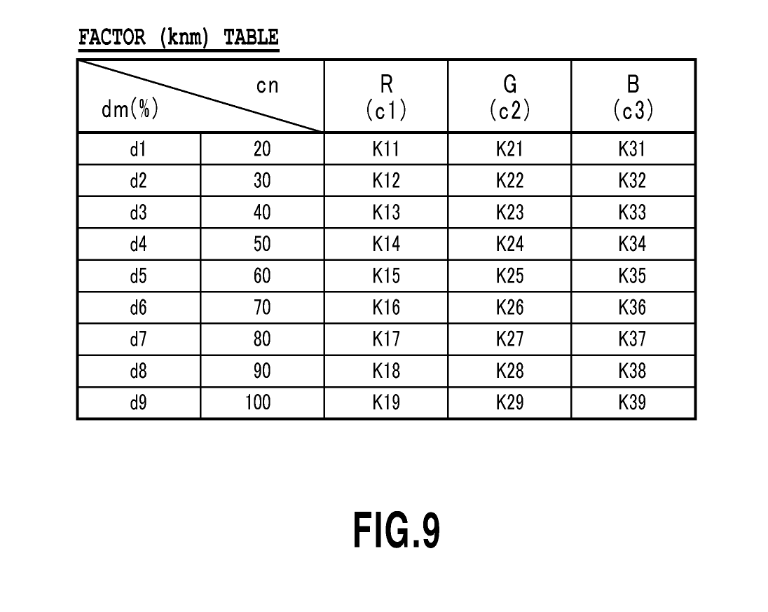

Suppose that the color difference of R, G, and B is a variable cn (R: c1, G: c2, B: c3), the print duty of a pattern is a variable dm (d1: 20%, d2: 30% . . . , d9: 100%), and the coefficient for ΔR, G, B at variables cn and dm is Knm. In this case, the coefficient table stored in the ROM 313 is just as shown in FIG. 9. In the figure, K11 to K39 are the values corresponding to each color and duty in FIG. 6. For instance, if the print duty is 30% and the color to be read is R, the coefficient would be K12 and the value is to be 1.2 as shown in FIG. 6.

Here, the differences between read values of each read colors R, G, and B obtained by the scanner reading a pattern printed by a print head with a standard ink ejection volume and read values of each read colors obtained by the same scanner by reading a pattern printed by an actual print head are defined as dR, dG, and dB. Further, when the ejection volume variation is defined as ΔVnm, dR, dG, dB and ΔVnm have the following relationship:

ΔVnm=dR, dG, dB/Knm (formula 1)

Based on the relationship shown by this formula 1, in S406, variation volumes dR, dG, and dB in read values are converted into ejection variation volume ΔVnm for each R, G, and B and by print duty of a pattern. The obtained values are set as evaluation values.

Next, the weighted average of the calculated corresponding value dVnm is obtained to find an average ejection volume variation (weighted average value) ΔVave (S407). The value ΔVave becomes a comprehensive evaluation value for ink ejection characteristics of print heads. The average ejection volume variation ΔVave can be obtained by the following formula when the weighted ratio by R, G, and B and by print duty of the pattern is Wnm.

$$\begin{matrix}[ Math 1 ] & \\ Δ Vave = \frac{{\sum }_{n = 1}^{3} {\sum }_{m = 1}^{9} Wnm \cdot dVnm}{{\sum }_{n = 1}^{3} {\sum }_{m = 1}^{9} Wnm} & ( Formula 2 )\end{matrix}$$

A method to determine the weighted ratio will be described below.

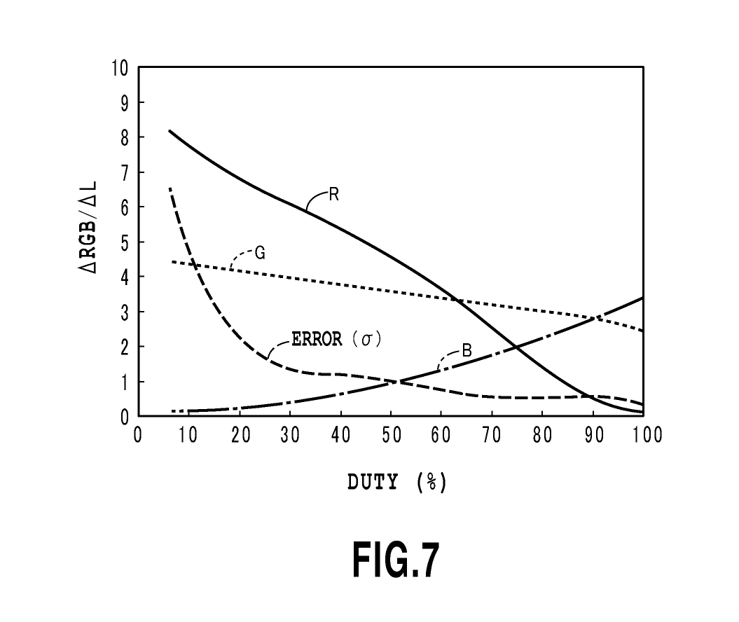

FIG. 7 is a diagram illustrating how the ratio of variation ΔR, G, B of read values obtained by the scanner (ΔR, G, B/ΔL) behaves when L of CIE-Lab is changed by ΔL in relation to the patterns with each print duty in FIG. 5, that is, when a brightness change that matches human vision is occurred. As shown in FIG. 7, ΔR, G, B sensitivities to the same variation of ΔL are varied depending on both the read color and duty of the pattern. In addition, “error (σ)” line in FIG. 7 is the value of standard variation obtained by finding measurement errors in ΔR, G, B/ΔL to each duty for each area of print heads. Further, although FIG. 7 shows errors in ΔR, G, B by a single line, error (σ) lines for each R, G, and B color are slightly different from each other in practice. However, since the difference between each line is not significant, the average value of errors in each R, G, and B color is shown in the figure.

In an ejection characteristics detection pattern printed by an inkjet printing apparatus, as shown in FIG. 7, the number of dots constructed is smaller as the print duty is lower. Therefore, an error is generated as the formed pattern becomes larger, and at the same time a significant error in a read value of printed pattern will be generated. Consequently, in a system in which the ejection characteristics detection pattern is printed and read, the measurement error becomes larger as the print duty becomes smaller.

Considering such characteristics shown in FIG. 7, read colors (R, G, B) and print duties that should be largely weighted are determined in accordance with the following criteria:

1. ΔRGB sensitivity as a detecting system to the brightness difference recognized by a human vision is high.
2. Measurement error is low.

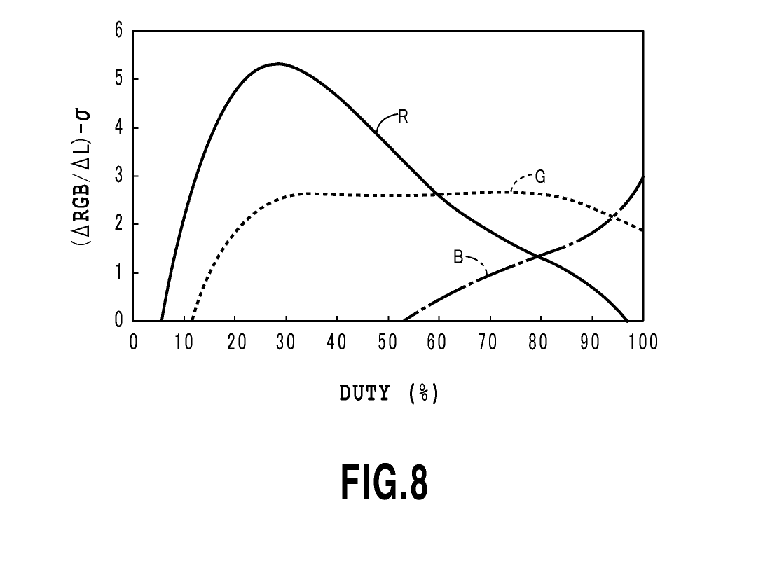

As described above, it is desirable to increase the weight of ΔVnm obtained based on the read values obtained with a print duty and read color that satisfies the condition in which S/N ratio (signal-to-noise ratio) becomes high at a high sensitivity, that is, the condition in which the scan accuracy becomes high. Taking this point into account, characteristics as shown in FIG. 8 will be studied.

FIG. 8 is a diagram illustrating the characteristics obtained by deducting errors (σ) from (ΔR, ΔG, ΔB)/ΔL of each R, G, and B color shown in FIG. 7. However, any part having a negative value is excluded. Since this characteristic is the value obtained by deducting “error” from “sensitivity”, it matches the above-described condition in which the weight should be increased. Therefore, the weighted value Wnm described above is determined by applying the characteristics (except that the negative part is considered as zero) of FIG. 8. That is, the weighted value Wnm is increased as the value obtained by deducting “error” from “sensitivity” becomes larger.

Using the Wnm determined in this way, the ejection volume variation value ΔVave expressed by the above formula 2 is determined eventually (S408), and correction of head shading is performed (S409) so that the ejection volume variation value ΔVave is decreased (to zero ideally). The correction of head shading is performed by a known method such as controlling the control value (pulse width, pulse voltage etc.) for the head ejection volume of driving pulse etc. or controlling the number of dots in image processing.

As described above, in the present embodiment, the same ejection characteristics detection pattern is read with a plurality of colors (R, G, B) and G, B, and the weighted average is obtained as applying a larger weight to the evaluation value (Vnm) based on the read value read under the condition in which the scan accuracy becomes higher. Therefore, the ejection characteristics evaluation of print heads can be performed highly precisely without increasing the area of ejection characteristics detection pattern as is conventionally done. As a result, the running cost can be reduced by lowering ink consumption and the print operation throughput can be improved.

The above paragraph explained the case in which the ejection characteristics detection pattern of C is read with G and B in addition to the complementary color (other than R) normally used. However, the ejection characteristics detection pattern of M can be read with read color B other than the complementary colors (other than G). In that case, just as in the case of ejection characteristics detection pattern of C, highly accurate evaluation is enabled without increasing the pattern area to be formed. However, since sensitivity of R to the detection characteristics detection pattern of M is very low (the value detected by the scanner 107 barely changes in relation to the change of ejection volume), reading with R is not conducted.

Therefore, based on the ejection characteristics detection pattern of M, the following formula 3 is applied to obtain the above described ΔVave.

$$\begin{matrix}[ Math 2 ] & \\ Δ Vave = \frac{{\sum }_{n = 1}^{2} {\sum }_{m = 1}^{9} Wnm \cdot dVnm}{{\sum }_{n = 1}^{3} {\sum }_{m = 1}^{9} Wnm} & ( Formula 3 )\end{matrix}$$

Further, since detection sensitivities of R and G to the ejection characteristics detection pattern of Y are very low, the pattern is read only by B.

### (First Variation of the Present Embodiment)

In the above described embodiment, as shown in FIG. 8, the weighted value Wnm is obtained by a simple deduction of (ΔR, G, B/ΔL)−σ, but the present invention is not limited by this. For example, for the purpose of increasing S/N ratio as a measurement system, the value deducted from ΔR,G,B/ΔL may be a value other than σ (for instance 2σ), or the weighted value may be obtained by ΔR,G,B/(ΔL·σ).

### (Second Variation of the Present Embodiment)

Further, in the step S407 of the above embodiment, ΔR, G, and B are independently weighted based on Knm to obtain the corresponding value ΔVnm. However, for the purpose of increasing S/N ratio as a measurement system, weight may be limited to 0% and 100% depending on the print duty. In this way, the calculation process can be simplified, and it is possible to respond to higher-speed printing.

### Other Embodiment

In the above embodiment, an example of a case in which the ejection characteristics detection apparatus and ejection characteristics detection method of the present invention are applied to a full-line type inkjet printing apparatus is described. However, the present invention can be applied to so-called serial type printing apparatuses that perform printing as moving print heads in the direction crossing the conveying direction of the print medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-143095, filed Jun. 23, 2010, which is hereby incorporated by reference herein in its entirety.

What is claimed is:

1. An ejection characteristics evaluation apparatus to evaluate ink ejection characteristics of a plurality of nozzles provided in print heads used for inkjet printers comprising:
a print control unit configured to print a plurality of ejection characteristics detection patterns with different print duties, that are ratios between the number of all pixels within a unit area and the number of pixels in which a dot is formed on a print medium, by the print heads;
a reading unit configured to divide each of the plurality of ejection characteristics detection patterns into areas having a predetermined number of pixels and to read each of the areas with a plurality of read colors;
an evaluation value setting unit configured to specify, based on the read values by the read color obtained by the reading unit for each area, an evaluation value for each of the read colors that indicates an ejection variation volume that is the difference, in each area, between ink ejection volume in each area and standard ink ejection volume; and
a comprehensive evaluation unit configured to obtain a weighted average value by applying weights determined based on reading accuracy of the reading unit to the evaluation value for each of the read colors of each area with different duties formed by the same nozzle and evaluate ejection characteristics of a nozzle that prints each of the areas using the weighted average.

2. An ejection characteristics evaluation apparatus for print heads according to claim 1, wherein
the inkjet printing apparatus has a plurality of print heads provided with a plurality of nozzles to eject ink, and
the plurality of print heads eject ink of different colors.

3. An ejection characteristics evaluation apparatus for print heads according to claim 1, wherein the higher the reading accuracy of the reading unit becomes, the larger the weights are configured to be.

4. An ejection characteristics evaluation apparatus for print heads according to claim 3, wherein the reading accuracy is specified corresponding to the read color and print duty of an ejection characteristics detection pattern to be read.

5. An ejection characteristics evaluation apparatus for print heads according to claim 1, wherein the reading accuracy is expressed by a characteristics obtained by removing errors from the sensitivity to the difference in brightness recognized by human vision.

6. An ejection characteristics evaluation apparatus for print heads according to claim 1, wherein the reading unit reads the ejection characteristics detection pattern printed by at least one of the plurality of print heads using a complementary color of the ink color used to print the pattern and a color other than the complementary color as the read colors.

7. An ejection characteristics evaluation apparatus for print heads according to claim 2, wherein
the plurality of print heads eject cyan ink, magenta ink, and yellow ink respectively, and
the reading unit reads the ejection characteristics detection pattern printed by at least one of the print heads that ejects cyan ink with at least green and blue read colors among red, green, and blue colors.

8. An ejection characteristics evaluation apparatus for print heads according to claim 2, wherein the reading unit reads the ejection characteristics detection pattern printed by at least one of the print heads that ejects magenta ink among the print heads with green and blue read colors.

9. An ejection characteristics evaluation apparatus according to claim 1, wherein the weight includes 0% and 100%.

10. An ejection characteristics evaluation apparatus according to claim 1, wherein the evaluation value setting unit preliminarily obtains the degree of efficiency of the reading unit to read value variations with respect to a certain amount of ejection volume variation of the print heads, and based on the read values by the read color obtained by the reading unit and the degree of efficiency, specifies evaluation values by the read color that indicate an ejection variation volume that is the difference between ink ejection volume in each area and standard ink ejection volume.

11. An ejection characteristics evaluation apparatus for print heads according to claim 1, wherein the reading unit divides each of the plurality of ejection characteristics detection patterns into areas with a plurality of pixels, reads pixels within the area with a plurality of different read colors, and defines an average of the read values by the read color of the plurality of pixels as a read value by the read color of the area.

12. An ejection characteristics evaluation method for print heads to evaluate ink ejection characteristics of a plurality of nozzles provided in print heads used for n inkjet printing apparatus comprising:
a pattern printing process to print a plurality of ejection characteristics detection patterns with different print duties, that are the ratios between the number of all pixels in a unit area and the number of pixels in which dots are formed on a print medium, by the print heads;
a read process to divide each of the plurality of ejection characteristics detection patterns into areas with a certain number of pixels and read each of the areas with a plurality of different read colors;
an evaluation value setting process to determine, based on the read values by the read color obtained by the reading unit for each area, an evaluation value for each of the read colors that indicates an ejection variation volume that is the difference, in each area, between ink ejection volume in each area and standard ink ejection volume; and
a comprehensive evaluation process to obtain a weight average by applying weights determined based on the reading accuracy of the reading unit to the evaluation value for each of the read colors of each area with different print duties formed by the same nozzle and evaluate ejection characteristics of a nozzle that prints each of the areas using the weighted average.

13. An inkjet printing apparatus to print an image on a print medium by using a plurality of print heads with a plurality of nozzles to eject ink and ejecting different ink colors from the plurality of print heads, the inkjet printing apparatus comprising:
a print control unit configured to print a plurality of ejection characteristics detection patterns with different print duties, that are the ratios between the number of all pixels within a unit area and the number of pixels in which dots are formed on a print medium, by the print head;
a reading unit configured to divide each of the plurality of ejection characteristics detection patterns into areas with a certain number of pixels and read each of the areas with a plurality of read colors;
an evaluation value setting unit configured to specify, based on the read values by the read colors obtained by the read method for each area, an evaluation value for each of the read colors that indicates an ejection variation volume which are the difference, in each area, between ink ejection volume in each area and standard ink ejection volume;
a comprehensive evaluation unit configured to obtain a weighted average value by applying weights determined based on reading accuracy of the reading unit to the evaluation value for each of the read colors of each area with different duties formed by the same nozzle and evaluate ejection characteristics of a nozzle that prints each of the areas using the weighted average; and
a correction unit configured to correct ink ejection volumes from the print heads to the print medium so that the weighted average value is decreased.
